(19) United States
(12) Patent Application Publication
(10) Pub. No.: US 2019/0273525 A1
(43) Pub. Date: Sep. 5, 2019

(54) ANTENNA POWER ADJUSTMENT METHOD

(71) Applicant: PEGATRON CORPORATION, TAIPEI CITY (TW)

(72) Inventors: Chien-Yi WU, TAIPEI CITY (TW); Chang-Hsun WU, TAIPEI CITY (TW); Tse-Hsuan WANG, TAIPEI CITY (TW); Chao-Hsu WU, TAIPEI CITY (TW); Ming-Huang CHEN, TAIPEI CITY (TW)

(21) Appl. No.: 16/211,458

(22) Filed: Dec. 6, 2018

(30) Foreign Application Priority Data
Mar. 2, 2018 (TW) 107107122

(51) Int. Cl. H04B 1/3827; H01Q 1/22; H04B 1/401; H04W 52/30; H04W 52/28; G06F 3/02

(52) U.S. Cl. CPC H04B 1/3838; H01Q 1/2266; H04B 1/401; H04W 52/288; H04W 52/283; G06F 3/0227; H04W 52/30

(57) ABSTRACT

An antenna power adjustment method is provided and applied to an electronic device. The antenna power adjustment method includes: performing position detection by a first acceleration detector and a second acceleration detector, where the first acceleration detector and the second acceleration detector are respectively disposed on a first plate and a second plate of the electronic device, and the first plate and the second plate are connected to each other by using a pivot of the electronic device for relative rotation; calculating an angle between the first plate and the second plate according to results of the position detection of the first acceleration detector and the second acceleration detector; and adjusting a power of an antenna of the electronic device according to the angle.

### CROSS-REFERENCE TO RELATED APPLICATIONS

This application is based upon and claims priority under 35 U.S.C. 119 from Taiwan Patent Application No. 107107122 filed on Mar. 2, 2018, which is hereby specifically incorporated herein by this reference thereto.

### BACKGROUND

### Technical Field

The present disclosure relates to antenna power adjustment technologies, and in particular, to an antenna power adjustment method.

### Related Art

An electronic device needs to receive and send data via electromagnetic waves during wireless communication. However, since the electromagnetic waves may cause harm to human body, the antenna power of the electronic device during wireless communication needs to be standardized, so that the antenna power is controlled within a safe range. However, the electronic device in different operating modes have different configuration relative to the human body. Therefore, the distance between the antenna and the human body needs to change with different operating modes.

### SUMMARY

An objective of the present disclosure is to provide an antenna power adjustment method, applied to an electronic device. The antenna power adjustment method includes: performing position detection by a first acceleration detector and a second acceleration detector, where the first acceleration detector and the second acceleration detector are respectively disposed on a first plate and a second plate of the electronic device, and the first plate and the second plate are connected to each other by using a pivot of the electronic device for relative rotation; calculating an angle between the first plate and the second plate according to a result of the position detection of the first acceleration detector and the second acceleration detector; and adjusting a power of an antenna of the electronic device according to the angle.

The advantage of applying the present disclosure is to calculate an angle between a first plate and a second plate by performing position direction by using a first acceleration detector and a second acceleration detector, and then adjust a power of an antenna in an electronic device according to a usage mode corresponding to the angle, thereby avoiding impact of electromagnetic waves on the human body when approaching to the electronic device.

### BRIEF DESCRIPTION OF THE DRAWINGS

FIG. 1A is a side view of an electronic device according to an embodiment of the present disclosure;

FIG. 1B is a block diagram of the electronic device in FIG. IA according to an embodiment of the present disclosure;

FIG. 2 is a flowchart of an antenna power adjustment method according to an embodiment of the present disclosure; and

FIG. 3A to FIG. 3D are respectively schematic diagrams of an electronic device in different operating modes according to an embodiment of the present disclosure.

### DETAILED DESCRIPTION

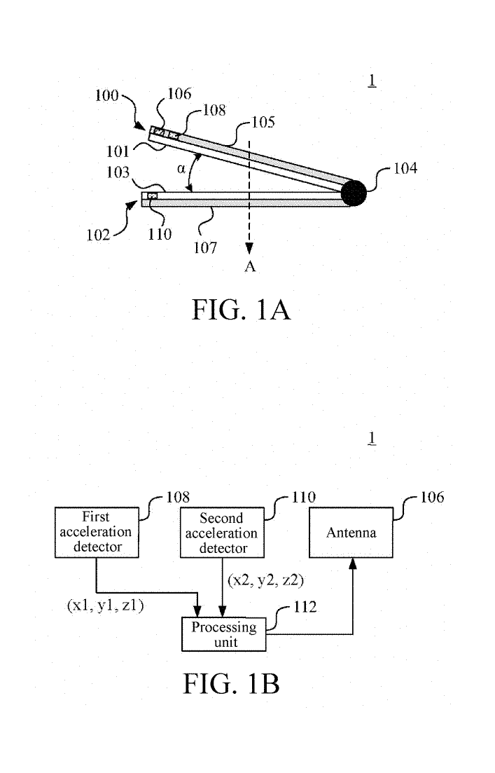

Referring to both FIG. 1A and FIG. 1B, FIG. 1A is a side view of an electronic device 1 according to an embodiment of the present disclosure, and FIG. 1B is a block diagram of the electronic device 1 in FIG. 1A according to an embodiment of the present disclosure.

The electronic device 1 includes a first plate 100, a second plate 102, a pivot 104, an antenna 106, a first acceleration detector 108, a second acceleration detector 110, and a processing unit 112.

In an embodiment, the electronic device 1 may be a notebook computer, a tablet electronic device, or another electronic device including two plates. The first plate 100 and the second plate 102 are connected to each other by using the pivot 104 for relative rotation.

In an embodiment, the first plate 100 includes a display screen setting surface 101 for disposing a display screen (not shown) in the plane. The second plate 102 includes a keyboard setting surface 103 for disposing a keyboard (not shown) on the plane. An angle a is included between the display screen setting surface 101 and the keyboard setting surface 103. In an embodiment, when the angle α is zero degree, the display screen setting surface 101 and the keyboard setting surface 103 are substantially parallel to each other.

It should be noted that the word “substantially” means that an error within a specific range may exist in terms of the completely parallel between the display screen setting surface 101 and the keyboard setting surface 103, which is not necessarily to be completely parallel to each other.

In an embodiment, an upper back cover 105 is disposed on the other surface of the first plate 100 arranged opposite to the display screen setting surface 101, and a lower back cover 107 is disposed on the other surface of the second plate 102 arranged opposite to the keyboard setting surface 103.

It should be noted that the foregoing configurations of planes and back covers are merely an example, but the present disclosure is not limited thereto.

In an embodiment, the antenna 106 is disposed in a surrounding area parallel to the first plate 100 and away from a side of the pivot 104. The antenna 106 is configured to transmit and receive a radio signal according to an operating power.

The first acceleration detector 108 and the second acceleration detector 110 are respectively disposed on the first plate 100 and the second plate 102, and are respectively configured to perform position detection. In an embodiment, the position detection performed by the first acceleration detector 108 and the second acceleration detector 110 is performed on a position relative to the direction of gravity.

It should be noted that positions on which the first acceleration detector 108 and the second acceleration detector 110 are disposed in FIG. 1A are merely an example, and the present disclosure is not limited thereto.

The processing unit 112 is electrically connected to the antenna 106, the first acceleration detector 108, and the second acceleration detector 110. In an embodiment, the processing unit 112 may receive results of the position detection of the first acceleration detector 108 and the second acceleration detector 110 for calculation, and control a signal receive and transmit power of the antenna 106.

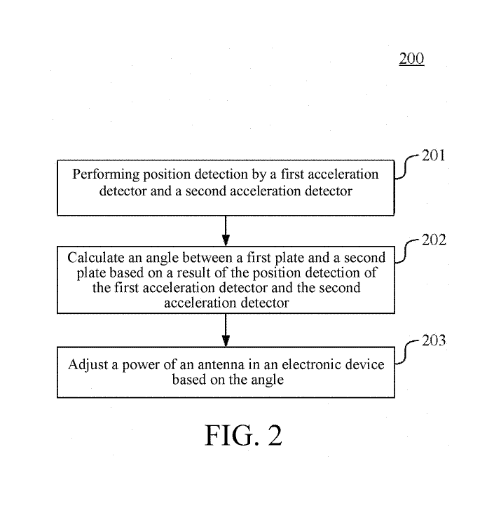

Referring to FIG. 2, FIG. 2 is a flowchart of an antenna power adjustment method 200 according to an embodiment of the present disclosure. The antenna power adjustment method 200 may be applied to, for example, the electronic device 1 in FIG. 1A and FIG. 1B. The following describes the antenna power adjustment method 200 in detail with reference to FIG. 1A, FIG. 1B, and FIG. 2.

The antenna power adjustment method 200 includes the following steps (it should be understood that the sequence of the steps mentioned in this implementation may be adjusted according to actual requirements unless the sequence is particularly stated, and even all or some of the steps may be simultaneously performed).

In step 201, the first acceleration detector 108 and the second acceleration detector 110 perform position detection.

As described above, in an embodiment, the position detection performed by the first acceleration detector 108 and the second acceleration detector 110 is performed on a position relative to the direction of gravity. Using the electronic device 1 shown in FIG. 1A as an example, when the second plate 102 is placed approximately parallel to the ground, the electronic device 1 senses gravity in a direction A. Therefore, the first acceleration detector 108 and the second acceleration detector 110 respectively detects the positions of the first plate 100 and the second plate 102 relative to the direction A.

In step 202, the processing unit 112 calculates an angle α between the first plate 100 and the second plate 102 according to results of the position detection of the first acceleration detector 108 and the second acceleration detector 110.

In an embodiment, the position of the first plate 100 relative to the direction A may be represented as (x1, y1, z1), and the position of the second plate 102 relative to the direction A may be represented as (x2, y2, z2). Therefore, the angle α may be represented by a vector inner product as:

α=cos⁻¹((x1·x2+y1·y2+z1·z2)/(\sqrt{x1²+y1²+z1²}·\sqrt{x2²+y2²+z2²})).

In step 203, the processing unit 112 adjusts the power of the antenna 106 in the electronic device according to the angle α.

In an embodiment, when the angle α falls within a first angle range, the processing unit 112 determines that a user is relatively far away from the antenna 106 in such an operating mode, and sets the power of the antenna 106 to a working power value. When the angle α falls within a second angle range, the processing unit 112 determines that the user is relatively close to the antenna 106 in such an operating mode, and sets the power of the antenna 106 to be less than the working power value.

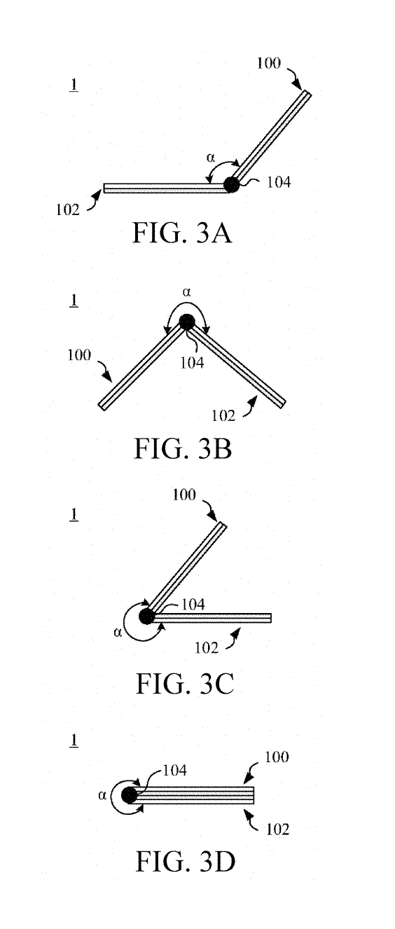

Referring to FIG. 3A to FIG. 3D, FIG. 3A to FIG. 3D are respectively schematic diagrams of the electronic device 1 in different operating modes according to an embodiment of the present disclosure.

In FIG. 3A, the angle α between the first plate 100 and the second plate 102 and that is calculated by the processing unit 112 is equal to or larger than 0 degree and less than 180 degrees. In this case, the processing unit 112 determines that the operating mode is a common notebook computer mode. The processing unit 112 further sets the power of the antenna 106 to a working power value.

In FIG. 3B, the angle α between the first plate 100 and the second plate 102 and that is calculated by the processing unit 112 is equal to or larger than 180 degrees and less than 225 degrees. In this case, the processing unit 112 determines that the operating mode is a standing mode. The processing unit 112 further sets the power of the antenna 106 to the working power value.

In FIG. 3C, the angle α between the first plate 100 and the second plate 102 and that is calculated by the processing unit 112 is equal to or larger than 225 degrees and less than 340 degrees. In this case, the processing unit 112 determines that the operating mode is a tent mode. The processing unit 112 further sets the power of the antenna 106 to be less than the working power value.

In FIG. 3D, the angle α between the first plate 100 and the second plate 102 and that is calculated by the processing unit 112 is equal to or larger than 340 degrees and less than 360 degrees. In this case, the processing unit 112 determines that the operating mode is a tablet computer mode. The processing unit 112 further sets the power of the antenna 106 to be less than the working power value.

According to the antenna power adjustment method 200 of the present disclosure, the first acceleration detector 108 and the second acceleration detector 110 may perform the position detection, to calculate the angle α between the first plate 100 and the second plate 102, and then adjust the power of the antenna 106 in the electronic device 1 according to a usage mode corresponding to the angle α, thereby avoiding impact of electromagnetic waves on the human body when approaching to the electronic device.

The foregoing descriptions are merely preferred embodiments of the present disclosure, and are not intended to limit the present disclosure. Any modification, equivalent replacement, or improvement made within the principle of the present disclosure should fall within the protection scope of the present disclosure.

What is claimed is:

1. An antenna power adjustment method, applied to an electronic device, wherein the antenna power adjustment method comprises:
performing position detection by a first acceleration detector and a second acceleration detector, wherein the first acceleration detector and the second acceleration detector are respectively disposed on a first plate and a second plate of the electronic device, and the first plate and the second plate are connected to each other by using a pivot of the electronic device for relative rotation;
calculating an angle between the first plate and the second plate according to results of the position detection of the first acceleration detector and the second acceleration detector; and
adjusting a power of an antenna of the electronic device according to the angle.

2. The antenna power adjustment method according to claim 1, wherein the first plate comprises a first surface, the second plate comprises a second surface, and the first surface is substantially parallel to the second surface when the angle is zero degree.

3. The antenna power adjustment method according to claim 2, wherein the first surface is a display screen setting surface, and the second surface is a keyboard setting surface.

4. The antenna power adjustment method according to claim 3, wherein the antenna is disposed in a surrounding area parallel to the first plate and away from a side of the pivot.

5. The antenna power adjustment method according to claim 2, wherein when the angle falls within a first angle range, the power of the antenna is set to a working power value, and when the angle falls within a second angle range, the power of the antenna is set to be less than the working power value.

6. The antenna power adjustment method according to claim 2, wherein when the angle is equal to or larger than 0 degree and less than 180 degrees, the method further comprises:
setting the power of the antenna to a working power value.

7. The antenna power adjustment method according to claim 2, wherein when the angle is equal to or larger than 180 degrees and less than 225 degrees, the method further comprises:
reducing the power of the antenna to a working power value.

8. The antenna power adjustment method according to claim 2, wherein when the angle is equal to or larger less than 225 degrees and less than 340 degrees, the method further comprises:
setting the power of the antenna to be less than a working power value.

9. The antenna power adjustment method according to claim 2, wherein when the angle is equal to or larger than 340 degrees and less than 360 degrees, the method further comprises:
reducing the power of the antenna to be less than a working power value.

10. The antenna power adjustment method according to claim 1, further comprising:
performing the position detection by using at least one third acceleration detector, to calculate the angle between the first plate and the second plate according to results of the position detection of the first, the second, and the third acceleration detectors.
